(19) United States
(12) Patent Application Publication
(10) Pub. No.: US 2026/0325933 A1
(43) Pub. Date: Oct. 22, 2026

(54) Interactive Immersive Basketball Court System

(71) Applicant: Neoja, Ltd., Tel Aviv (IL)

(72) Inventors: Eliran FARHI, Bet Hashmonai (IL); Sagi SHEFA, Tel Aviv (IL); Yariv SHEFA, Tel Aviv (IL); Jeremie KLETZKINE, Tel Aviv (IL)

(73) Assignee: Neoja, Ltd., Be Hashmonai (IL)

(21) Appl. No.: 19/180,724

(22) Filed: Apr. 16, 2025

(51) Int. Cl. A63B 63/08; A63B 24/00; A63B 71/06; G07F 17/32

(52) U.S. Cl. CPC A63B 63/083; A63B 24/0062; A63B 71/0605; A63B 2024/0025; A63B 2024/0037; A63B 2071/0625; A63B 2220/05; A63B 2220/40; A63B 2220/805; A63B 2225/093; A63B 2225/15; G07F 17/3288

(57) ABSTRACT

The present disclosure provides an interactive basketball court system and method of playing a game. The system includes a court with adjustable basketball boards, sensors for detecting shot accuracy and player movements, cameras for tracking player positions, and a centralized communication and analysis system. Real-time audiovisual feedback is projected onto walls and the court floor. The system incorporates a software system for custom game design, RFID bracelets for player access control, and a betting system for non-playing participants. A highlight system records gameplay, detects key events, and allows user-triggered highlight saving. The method involves players entering the court, validating access via RFID, starting the game, interacting with projected visuals and audio feedback, and reviewing results upon game completion. The system enables an immersive and customizable basketball experience with integrated tracking, analysis, and engagement features.

### CROSS-REFERENCE TO RELATED APPLICATIONS

None.

### FIELD OF INVENTION

The present disclosure relates to interactive sports systems, and more particularly to an immersive basketball court system incorporating sensor technology, real-time audiovisual feedback, and customizable gameplay features.

### BACKGROUND

Basketball has long been a popular sport enjoyed by players and spectators alike. Traditional basketball courts provide a static playing environment with fixed elements such as the court boundaries, hoops, and backboards. While this setup has served the sport well for decades, there is growing interest in enhancing the basketball experience through the integration of modern technology.

In recent years, efforts have been made to incorporate digital elements into sports and fitness activities. These innovations aim to increase engagement, provide real-time feedback, and create more immersive experiences for participants. However, many existing solutions for basketball focus on individual training aids or basic scoring systems, rather than transforming the entire court environment.

There are challenges in developing comprehensive interactive basketball systems. These include accurately tracking player movements and ball trajectories in real-time, providing meaningful audiovisual feedback without disrupting gameplay, and creating customizable experiences that appeal to players of varying skill levels. Additionally, integrating multiple technological components into a cohesive system while maintaining the core elements of basketball presents both technical and design hurdles.

Prior art in this field includes various attempts to enhance basketball gameplay and training:

U.S. Patent Publication No. 20090045578 describes a multimedia basketball machine that incorporates a digital camera and display screen. This system allows for video recording of players and playback on the screen, as well as the creation of player ranking charts. However, it is limited to a single machine setup and does not provide an immersive court-wide experience.

U.S. Patent Publication No. 20230012632 discloses a basketball system with an expanded court layout, including new scoring areas and a redesigned backboard. While this system introduces novel gameplay elements, it does not incorporate interactive digital features or real-time feedback mechanisms.

U.S. Patent No. 11305176 presents a system for providing performance indicators related to basketball shooting accuracy. It utilizes sensors on the backboard to track shot trajectories but is primarily focused on shot analysis rather than creating an interactive playing environment.

U.S. Patent No. 9283431 describes a trajectory detection and feedback system for basketball. This invention uses cameras and sensors to analyze shot parameters and provide audio feedback to players. However, it does not offer a fully immersive court experience or integrate multiple gameplay elements.

U.S. Patent Publication No. 20230338806 outlines a smart backboard system with integrated sensors, cameras, and a display screen. While this system provides shot analysis and feedback, it is limited to interactions centered around the backboard rather than encompassing the entire court space.

These prior art examples demonstrate ongoing efforts to enhance basketball through technology. However, there remains a need for a comprehensive system that transforms the entire basketball court into an interactive, immersive environment capable of supporting various gameplay modes and providing real-time feedback to players.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present invention provides an interactive and immersive basketball court system that integrates advanced sensor technology, real-time audiovisual feedback, and customizable gameplay features. The system transforms a standard basketball court into a dynamic playing environment, enhancing player engagement, training, and entertainment through the use of tracking cameras, sensors, interactive projections, and a centralized game operating system.

According to an aspect of the present disclosure, a basketball court system is provided. The system includes at least one basketball board, a plurality of sensors for detecting shot accuracy and player movements, a plurality of cameras for tracking player positions and game interactions, a centralized communication and analysis system that collects and processes gameplay data, a projection system for displaying real-time audiovisual feedback onto at least one surface of the court, and a game operating system enabling custom game design and updates.

According to another aspect of the present disclosure, a method of operating an interactive basketball court is provided. The method includes validating user access to the court, activating sensors and cameras to track player activity on the court, processing collected gameplay data, and providing real-time audiovisual feedback based on the processed data.

According to a further aspect of the present disclosure, a non-transitory computer-readable medium storing instructions is provided. When executed by a processor, the instructions cause the processor to perform operations for an interactive basketball game. The operations include receiving data from a plurality of sensors and cameras monitoring a basketball court, analyzing the received data to identify game events and player actions, generating real-time audiovisual feedback based on the analyzed data, and controlling at least one adjustable feature of the basketball court based on the analyzed data.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an environment in which an interactive immersive basketball court system is implemented in a basketball court, in accordance with one embodiment of the present invention.

FIG. 2 illustrates a block diagram of the interactive immersive basketball court system, in accordance with one embodiment of the present invention.

FIG. 3 illustrates a top-down view of the basketball court having sensors and cameras, and projection areas on the court floor, in accordance with one embodiment of the present invention.

FIG. 4 illustrates a side view of the height-adjustable and rotatable basketball board, in accordance with one embodiment of the present invention.

FIG. 5 is a block diagram of a RFID bracelet system, in accordance with one embodiment of the present invention.

FIG. 6 illustrates a method of operating an interactive immersive basketball court system operating, in accordance with one embodiment of the present invention.

FIG. 7 illustrates a method of operating a game operating system by administrators or users for creating and modifying game modes, in accordance with one embodiment of the present invention.

FIG. 8 illustrates a method of detecting key events by a highlight system for generating highlight reels, in accordance with one embodiment of the present invention.

FIG. 9 illustrates a general process flow depicting the sequence of events from user registration to game completion, in accordance with one embodiment of the present invention.

### DETAILED DESCRIPTION

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element’s relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

The interactive immersive basketball court system transforms a traditional basketball court into a dynamic, technology-driven environment that enhances player engagement and provides a unique gaming experience. The system incorporates advanced sensor technology, real-time audiovisual feedback, and a customizable software system to create an immersive playing environment.

In some cases, the basketball court may have dimensions of approximately 27 feet in length and 24 feet in width, with a tolerance of plus or minus 3 feet in each direction. The height of the playing area may be approximately 20 feet, with a tolerance of plus or minus 2 feet. These dimensions allow for a compact yet functional space that can accommodate various gameplay scenarios and interactive elements.

The system integrates multiple components to create a seamless and engaging experience. Tracking cameras positioned around the court monitor player movements and ball trajectory in real-time. Sensors embedded in the basketball boards and hoops detect precise interactions such as ball bounces, throws, and scoring events. This sensor and camera network feeds data into a centralized game operating system, which processes the information and manages gameplay mechanics, scoring, and player feedback.

An interactive projection system displays immersive visuals on the walls and floor of the court. These projections may be tailored to specific gameplay scenarios, such as displaying targets, dynamic scoring zones, or real-time statistics. The visual elements synchronize with player and ball movements to create a responsive and interactive experience.

The system incorporates an audio-visual feedback mechanism that provides real-time sound effects and commentary. This auditory component enhances player engagement and complements the visual feedback to create a fully immersive environment.

In some implementations, players may use RFID bracelets or wearable devices for personal identification and tracking of individual statistics. This feature allows for personalized experiences, such as tracking progress over time or selecting specific game modes.

The game operating system enables customization of games, tracks performance metrics, and provides insights through visual displays. Administrators may design and upload new game modes, ensuring that the system remains adaptable and offers fresh experiences over time.

The interactive immersive basketball court system combines these elements to create a unique and engaging experience that blends physical play with digital enhancements. By integrating advanced tracking technology, real-time feedback, and customizable gameplay, the system offers a novel approach to basketball that can appeal to players of various skill levels and preferences.

The sensor-based basketball shot detection system incorporates a combination of optical sensors and accelerometers to accurately determine the outcome of basketball shots.

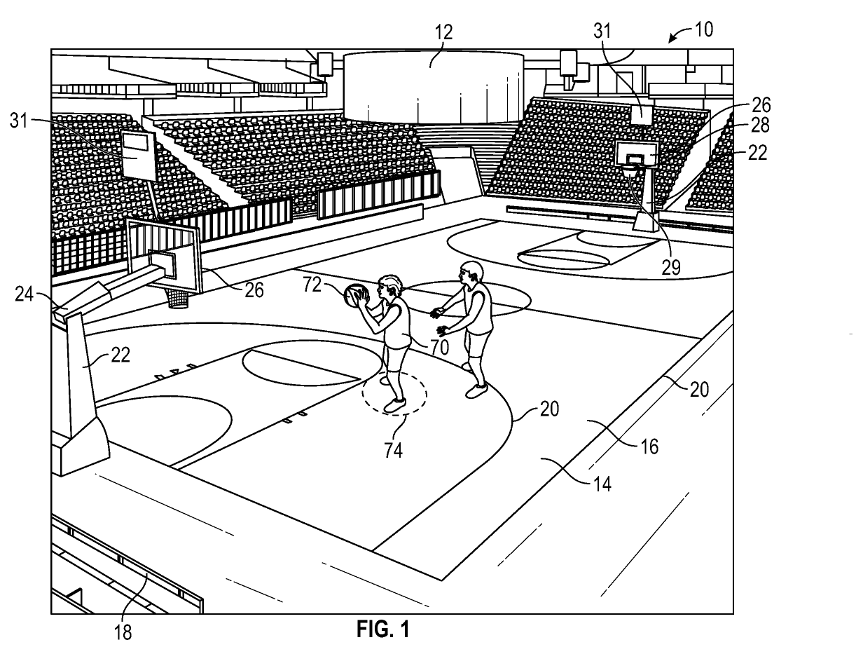

FIG. 1 shows an environment 10 in which an interactive immersive basketball court system 12 implements, in accordance with one embodiment of the present invention. For ease of reference, interactive immersive basketball court system 12 is referred to as system 12, hereinafter. System 12 implements in a court 14. In the present example, court 14 indicates a basketball court. It should be understood that system 12 may be configured to provide interactive and immersive experience for users in other courts such as tennis court, or any other court depending on the need. Court 14 may come in full size or half of standard court size, or may come in customized dimensions depending on the need. In some cases, court 14 may have dimensions of approximately 27 feet in length and 24 feet in width, with a tolerance of plus or minus 3 feet in each direction. The height of the playing area may be approximately 20 feet, with a tolerance of plus or minus 2 feet. In one example, court 14 size may range from 24 feet to 30 feet in length and 21 feet to 27 feet in width to accommodate different space requirements or gameplay preferences. These dimensions allow for a compact yet functional space that can accommodate various gameplay scenarios and interactive elements.

Court 14 presents a floor 16 and/or walls 18 depending on the need. Considering court 14 to be a basketball court, court 14 encompasses court lines 20 such as baselines, side and back lines (boundary lines), half-court line, a 3-point line, a free throw Line, a free throw circle, lane lines, and a center circle. Court lines 20 might be illuminated to offer enhanced experience during the play.

Court 14 includes poles 22 placed at opposite ends. Each pole 22 includes an extended arm 24 holding a basketball board 26. Basketball board 26 presents a rim 28 having a net 30. In the present embodiment, basketball board 26 includes a display 31 at the top. Optionally, display 32 may position at different locations to display points scored by players/team or highlight reels, etc.

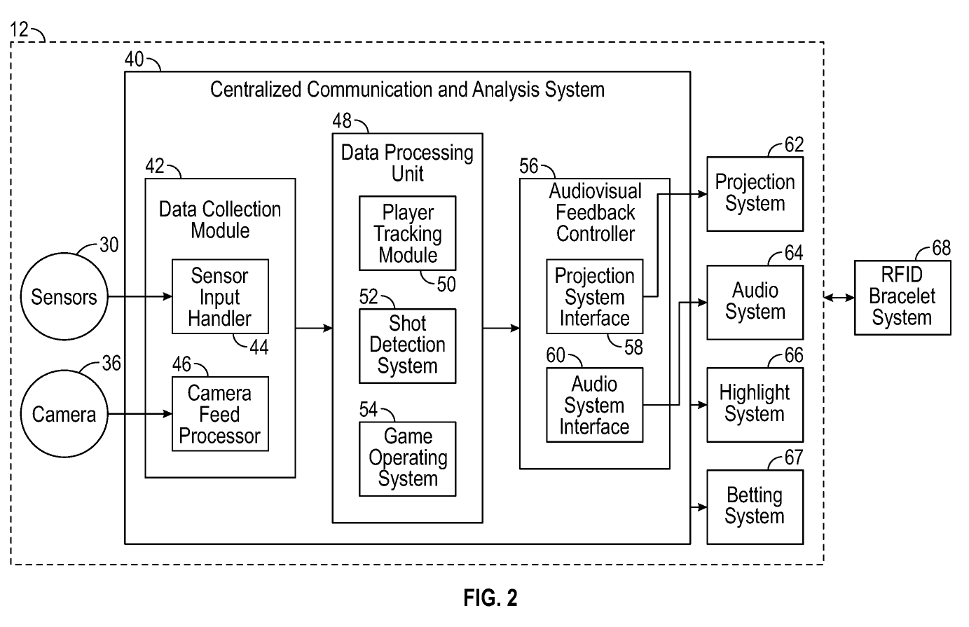

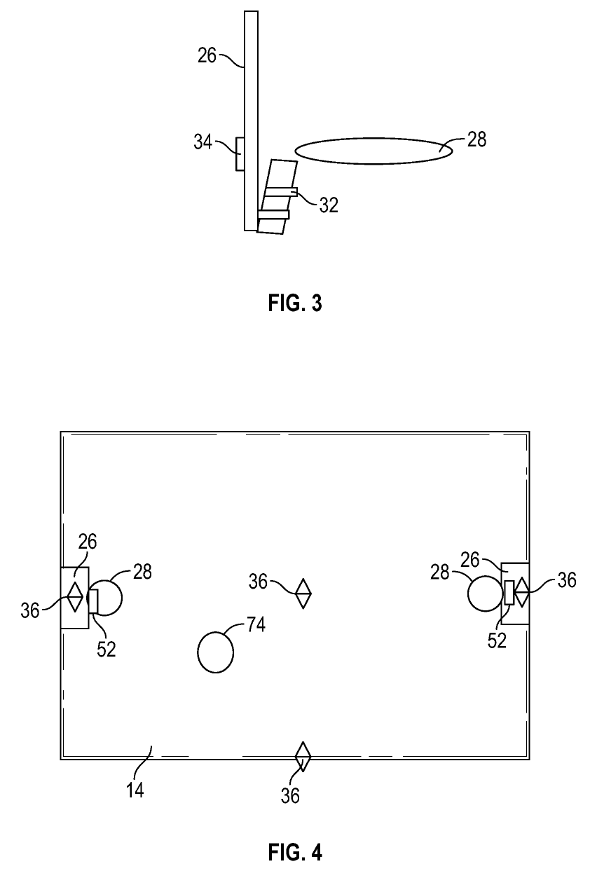

In one exemplary embodiment, system 12 mounts at a roof (not shown, similar to FIG. 1) or at an entrance or at walls 18 of court 14. It should be understood that system 12 may position at a single location within court 14 or components of system 12 be distributed within or with external devices without departing from the scope of the present invention. Referring to FIG. 2, a block diagram of system 12 is shown, in accordance with one exemplary embodiment of the present invention. System 12 integrates multiple components to create a seamless and engaging experience. System 12 includes sensors 30 such as optical sensors 32 and/or accelerometers 34 positioned at various places in court 14. FIG. 3 shows a top-down view of court 14 having dimensions, approximately 27x24 feet. FIG. 3 may depict the placement of adjustable basketball board 26 at each end of court 14 and locations of sensors 30 and cameras 36 positioned around court 14 and near basketball board 26. It should be understood that sensors 30 are embedded in basketball board 26 and net 30 to detect precise interactions such as ball bounces, throws, and scoring events. FIG. 3 also depicts projection areas 74 on floor 16 and/or walls 18, highlighting where audiovisual feedback (light projection) can be displayed during gameplay.

In some cases, optical sensors 32, say two optical sensors 32 may be arranged in a sequential configuration. When a basketball 72 passes through rim 28, optical sensors 32 may be triggered in a specific order. For example, if a first optical sensor 32 and a second optical sensor 32 are triggered in sequence, system 12 may determine this as a successful basket. Conversely, if second optical sensor 32 and first optical sensor 32 are triggered in sequence, system 12 may determine this as no basket.

In some implementations, system 12 may incorporate a color sensor (not shown) to identify the ball's color. This additional color sensor may provide another layer of analysis to enhance the accuracy of shot detection and potentially differentiate between multiple balls in use.

Accelerometers 34 may include two accelerometers 34 to detect ball impact on basketball board 26 or rim 28. Accelerometers 34 may be positioned to measure vibrations or sudden changes in acceleration caused by basketball 72 striking basketball board 26 or rim 28. In some cases, when either a first accelerometer 34 or a second accelerometer 34 is triggered, system 12 may initiate a waiting period, such as 1.27 seconds, to monitor subsequent events. During this monitoring period, system 12 may analyze readings from accelerometers 34 to determine if they fall below a threshold value over time. If both optical sensors 32 are triggered during this period, system 12 may determine this as a successful basket. If system 12 conditions are not met, system 12 may determine this as no basket.

Alternative sensor arrangements may be employed in different versions of system 12. For example, additional sensors (not show) may be integrated into floor 16 to detect player foot placement or ball bounces. In some cases, pressure-sensitive panels or infrared sensors (not shown) may be used to supplement or replace certain optical sensors 32 or accelerometers 34.

Further, system 12 includes one or more cameras 36. Cameras 36 are positioned around court 14 to monitor movement of players 70 and/or a trajectory of basketball 72 during the gameplay. FIG. 4 shows an exemplary placement of cameras 36 in court 14. A person skilled in the art understands that cameras 36 may be placed at different locations in court 14 to monitor player movements and ball trajectory in real-time. System 12 may incorporate multiple cameras 36 positioned strategically around the perimeter of court 14. In some implementations, six cameras 36 may be utilized, with one camera 36 located at each corner of the rectangular court and two additional cameras 36 positioned at the midpoints of the longer sides of court 14. This arrangement may provide comprehensive coverage of the playing area, enabling accurate tracking of player movements and game actions from multiple angles. The number and positioning of cameras 36 may vary in different implementations. For instance, some systems 12 may employ four cameras 36, one at each corner, while others may use eight or more cameras 36 for enhanced tracking precision. In some cases, overhead cameras 36 may be added to provide a top-down view of court 14.

The layout of court 14 and positioning of sensors 30 and cameras 36 may allow for complete monitoring of gameplay activities across the entire court surface. The arrangement of cameras 36 may provide overlapping fields of view, while the detection systems may be located to accurately track ball trajectories and interactions with the basketball equipment. The system's components may be integrated to work together, with cameras 36 providing visual tracking capabilities while sensors 30 offering precise detection/measurement of shooting outcomes. This configuration may enable the collection of comprehensive gameplay data for processing by the system's software.

System 12 includes a centralized communication and analysis system (CCA system) 40. CCA system 40 serves as the core of system 12, coordinating data flow and managing interactions between various subsystems. In some cases, CCA system 40 may be a high-performance computer or server capable of real-time data processing and analysis. CCA system 40 receives input from multiple sources, including cameras, sensors, and user interface devices.

System 12 may utilize a distributed network architecture to facilitate communication between components. In some implementations, the network may be based on Ethernet or fiber optic connections to ensure high-speed, low-latency data transfer. Wireless technologies such as Wi-Fi or 5G may also be employed for certain components, providing flexibility in installation and maintenance.

Data from sensors 30 and cameras 36 and may be transmitted to CCA system 40 in real-time. CCA system 40 processes this information to determine player positions, ball trajectory, and game events. Based on this processed data, system 12 generates appropriate audiovisual feedback and updates game statistics.

The communication protocol between components may be standardized to ensure compatibility and ease of integration. In some cases, a custom protocol may be developed to optimize performance for the specific requirements of the basketball court system.

For scalability, system 12 architecture may be designed to support multiple court setups or larger installations. This may involve implementing a hierarchical structure where individual court systems communicate with a master control unit. Such an arrangement allows for centralized management of multiple courts while maintaining the ability for each court to operate independently.

In some implementations, system 12 may utilize cloud computing resources for data storage, advanced analytics, or remote management capabilities. This approach can enhance system flexibility and allow for easier updates and maintenance.

CCA system 40 includes a data collection module 42. Data collection module 42 includes a sensor input handler 44 and a camera feed processor 46. Here, sensor input handler receives data from sensors 30, and camera feed processor 46 receives data from cameras 36. The data is further processed to manage gameplay mechanics, scoring, and player feedback. Further, CCA system 40 includes a data processing unit 48. Data processing unit 48 includes a player tracking module 50, a shot detection system 52 and a game operating system or a game logic processor 54.

Player tracking module 5 utilizes computer vision algorithms to interpret data from cameras 36 and identifies individual players 70 and tracks their movements throughout the game. In some cases, player tracking module 50 incorporates machine learning techniques to improve tracking accuracy over time and adapt to different player styles and court conditions. In some cases, player tracking module 50 may log player attendance, track usage patterns, and generate analytics to inform facility management decisions and improve overall user experience.

Shot detection system 52 positions adjacent to each basketball board 26. Shot detection system 52 may be built using a combination of optical sensors 32 and accelerometers 34 to monitor ball interactions with basketball board 26 and/or rim 28. In some implementations, two optical sensors 32 and two accelerometers 34 may be used for shot detection system 52, as explained using FIG. 3. Shot detection system 52 may incorporate detection algorithms to monitor ball interactions with basketball board 26 and/or rim 28. The detection algorithms may be refined to account for different shot types, such as bank shots or dunks, which may produce different sensor activation patterns. In some implementations, machine learning techniques may be employed to improve the system's accuracy over time by analyzing patterns in sensor data and correlating them with known shot outcomes. In some cases, shot detection system 52 may process data from optical sensors 32 and accelerometers 34 near backboards 26 to accurately determine shot outcomes. Shot detection system 52 may apply complex algorithms to differentiate between various types of shots, such as layups, jump shots, or three-pointers, and provide detailed analytics on shooting performance.

Game operating system 54 acts as a game engine responsible for coordinating the various subsystems of the interactive court. Game operating system 54 may process input from sensors 30 and cameras 36 in real-time, apply game rules and logic to determine the current state of play. Game operating system 54 may also manage the flow of data between different modules, ensuring smooth operation of the entire system 12. Game operating system 54 may allow for the creation, modification, and execution of various gameplay scenarios. Game operating system 54 may support both predefined game modes and user-created custom modes, providing flexibility for different skill levels and training objectives. Game operating system 54 may include a comprehensive data management and analytics module (not shown). Game operating system 54 may collect and store gameplay data, player statistics, and system performance metrics. In some cases, Game operating system 54 may incorporate big data processing techniques to generate insights, identify trends, and support decision-making for players, coaches, and system administrators.

Further, CCA system 40 includes an audiovisual feedback controller 56. Audiovisual feedback controller 56 operatively connects to game operating system 54 and provides feedback to players or users 70. The feedback may take the form of projections onto court 14 or sides of court 14, as well as audio feedback. The audiovisual feedback may be dynamically adjusted based on the ongoing gameplay. In one implementation, audiovisual feedback controller 56 includes a projection system interface 58, and an audio system interface 60. Projection system interface 58 includes an interface allowing players or users 70 to configure the visual feedback such as lighting control, color to be projected onto court 14, etc. Audio system interface 60 includes an interface allowing players or users 70 to configure the audio feedback based on shots or scores, etc.

In one example, projection system interface 58 may allow players 70 to design custom court layouts through the game design interface. In some implementations, projection system interface 58 may offer a drag-and-drop interface where users can place virtual elements such as additional hoops, obstacles, or target zones on a digital representation of the court. These custom layouts may then be projected onto the physical court surface (similar to projection areas 74 shown in FIG. 1 and/or FIG. 4) during gameplay, creating unique challenges and gameplay experiences by a projection system 62.

The projection system interface 58 may also allow users to set specific win conditions for their custom games. In some cases, users may be able to create games that end after a certain number of points are scored, when a specific skill challenge is completed, or based on other custom criteria. This feature may enable the creation of focused training exercises or innovative competitive formats.

In some implementations, projection system interface 58 may offer a library of pre-designed game elements that users can incorporate into their custom formats. These elements may include things like moving targets, time-limited scoring zones, or virtual defenders. Users may be able to combine and customize these elements to create complex and engaging game scenarios.

The game operating system 54 may include options for setting player roles or restrictions within custom game formats. For example, users may be able to designate certain players as shooters, rebounders, or defenders, with specific rules or scoring systems applied to each role. This feature may encourage teamwork and allow for the creation of specialized training scenarios.

In some cases, game operating system 54 may support the creation of multi-stage games or tournaments through the custom game design interface. Users may be able to link multiple game formats together, with progression rules and cumulative scoring across stages. This capability may enable the organization of complex events or training programs that evolve over time.

Users may have the option to save and share their custom game formats through the system. In some cases, a community platform may allow users to upload their creations, rate designs created by others, and collaborate on game format development. This sharing capability may foster a vibrant ecosystem of user-generated content, continuously expanding the variety of available gameplay experiences.

After processing the data, system 12 may employ a projection system 62 to project or display dynamic visuals onto floor 16 and surrounding walls 18. Projection system 62 utilizes projection technology to display dynamic visuals on three walls 18 surrounding court 14 and on the court floor 16 itself. Projection system 62 may include high-definition projectors strategically positioned to cover the entire playing area and surrounding walls 18. These projectors may be capable of displaying crisp, vibrant images that respond in real-time to player actions and game events. Projection system 62 may be designed to minimize shadows and maintain image quality even under varying lighting conditions. In some implementations, projection system 62 may display interactive targets, scoring zones, player statistics, or thematic elements that respond to in-game actions.

The visual feedback provided by projection system 62 may serve multiple purposes. In some implementations, projection system 62 may display scoring information, player statistics, and game timers directly on the court surface or walls. This allows players to easily track their performance without needing to look away from the playing area.

In other cases, the projections may create interactive targets or obstacles on floor 16 (similar to projection areas 74), adding new dimensions to gameplay. For example, illuminated zones (similar to projection areas 74) may appear on the court, challenging players to make shots from specific locations or avoid certain areas while dribbling. Projection system 62 may also project virtual defenders or passing lanes, helping players practice decision-making and spatial awareness.

Walls 18 surrounding court 14 may be used to display larger visual elements such as crowd animations, replays of notable plays, or thematic backgrounds that change based on the game mode or player preferences. In some implementations, these wall projections may extend the perceived size of the playing area, creating an immersive environment that goes beyond the physical boundaries of court 14.

System 12 may employ an audio system 64, such as speakers to incorporate sound effects or spatial audio cues that correspond to on-court events. Audio system 64 may be integrated with projection system 62 to provide sound effects, music, and vocal cues that correspond with the on-court action. In some cases, directional speakers may be used to create localized audio zones, allowing different sounds to be heard in different areas of the court without interference.

The audio feedback may include realistic basketball sounds such as ball bounces, swishes, and crowd reactions. In other implementations, audio system 64 may provide verbal coaching cues or encouragement based on player performance. Background music may also be dynamically adjusted to match the intensity of gameplay or to signal specific events like time running low or bonus point opportunities.

It should be understood that system 12 enables projection system 62 and audio system 64 to provide real-time audiovisual feedback to enhance the gameplay experience. This generates dynamic visual effects and audio cues based on gameplay events, player actions, predefined game modes. In some implementations, system 12 employs projection system 62 and audio system 64 to support real-time rendering of complex graphics and spatial audio processing to create an immersive playing environment.

Synchronization between the visual and audio elements and the actual gameplay may be achieved through the data provided by CCA system 40. Audiovisual feedback controller 56 may process data from the court's sensors 30 and cameras 36 in real-time, triggering appropriate audiovisual responses with minimal latency. For example, when a player scores a basket, audiovisual feedback controller 56 may simultaneously project a visual celebration effect on the court and walls while playing a triumphant sound through the speakers.

Audiovisual feedback controller 56 may offer customization options to suit different preferences and game modes. In some implementations, players or administrators may be able to select from a variety of visual themes, sound packs, or feedback styles. This customization may extend to the intensity and frequency of audiovisual feedback, allowing for adjustment based on player skill level or specific training objectives.

In certain cases, audiovisual feedback controller 56 may adapt its audiovisual feedback based on player performance or game progress. For instance, the difficulty of projected targets may increase as a player's accuracy improves, or the audio cues may become more frequent during critical moments of a close game.

The integration of this immersive audiovisual feedback controller 56 with the interactive basketball court 14 creates a dynamic, responsive environment that blends physical play with digital enhancements. This combination may provide players with a unique, engaging experience that goes beyond traditional basketball gameplay while offering new opportunities for skill development and entertainment.

In one implementation, system 12 includes a highlight system 66. Highlight system 66 analyzes gameplay footage from CCA system 40 in real-time, identifying significant events or impressive plays. In some cases, highlight system 66 may use Artificial Intelligence (AI) algorithms to automatically edit and compile highlight reels, while also allowing for user-triggered highlight saving. Highlight system 66 may provide advantages in terms of content creation and sharing. Highlight system 66 detects key events and user-triggered highlights and streamlines the process of creating engaging video content, potentially increasing the social media presence and marketability of the basketball facility.

In some implementations, highlight system 66 may allow users to manually trigger the key events to save memorable moments. When a user activates this feature, highlight system 66 may save a segment of video footage preceding the trigger point. The duration of this saved segment may range from 6 to 10 seconds prior to the user-triggered event.

The video processing techniques employed by highlight system 66 may involve real-time analysis of the gameplay footage. In some cases, computer vision algorithms may be utilized to identify specific actions or events on the court. These algorithms may analyze player movements, ball trajectories, and interactions with the basketball equipment to detect noteworthy moments.

The event detection algorithms may work in conjunction with the sensor data collected from court 14. For example, highlight system 66 may correlate visual cues from the video feed from cameras 36 and data from sensors 30 to accurately identify successful baskets or missed attempts.

In some implementations, highlight system 66 may integrate with the overall gameplay experience by providing instant replay capabilities. Users may have the option to review key moments immediately after they occur, enhancing engagement and allowing for quick analysis of performance.

Highlight system 66 may compile the detected key events and user-triggered highlights into a comprehensive highlight reel at the conclusion of each game. This compilation may be made available to users for review, sharing, or further analysis.

In some cases, highlight system 66 may incorporate machine learning techniques to improve its event detection capabilities over time. The system may learn from user-triggered highlights and refine its algorithms to better identify moments that players find significant.

The video processing component of highlight system 66 may also include features for enhancing the visual quality of the recorded footage. This may involve techniques such as image stabilization, color correction, or automatic framing to ensure that the highlights are presented in the best possible manner.

In some implementations, highlight system 66 may allow for customization of the types of events that are automatically detected and saved. Users may have the ability to set preferences for the kinds of plays or actions they want the system to prioritize in creating highlights.

The integration of highlight system 66 with the overall gameplay experience may extend to audiovisual feedback controller 56. In some cases, when a user triggers a highlight save, highlight system 66 may provide visual or auditory confirmation, enhancing the interactive nature of the gameplay.

In some implementations, system 12 includes a betting system 67. Betting system 67 enhance spectator engagement and create new revenue opportunities for operators of court 14. System 12 may integrate betting system 67 with highlight system 66 to offer a more interactive and informed betting experience compared to traditional sports wagering. In some implementations, betting system 67 may allow non-playing participants to engage with ongoing games. Betting system 67 may be integrated with game operating system 54 to provide real-time updates and facilitate seamless interaction.

The integration of betting system 67 and highlight system 66 may require additional data processing and storage capabilities. Highlight system 66 and betting system 67 may operate on dedicated hardware or may be integrated into CCA system 40, depending on the specific implementation and performance requirements.

To ensure reliability and minimize downtime of system 12, redundancy measures may be implemented in critical components. For example, backup processing units or failover mechanisms may be incorporated to maintain system operation in case of hardware failures.

System 12 may also include interfaces for external systems, such as facility management software or ticketing systems. These interfaces allow for seamless integration with existing infrastructure and enhance the overall functionality of the basketball court system.

In some cases, system 12 may incorporate machine learning algorithms to improve performance over time. These algorithms may analyze gameplay data to refine tracking accuracy, enhance audiovisual effects, or optimize game mechanics based on user engagement metrics.

The communication system may also include security measures to protect sensitive data and prevent unauthorized access. This may involve encryption protocols, secure authentication mechanisms, and regular security audits to ensure the integrity of the system.

In some cases, betting system 67 may allow spectators to place wagers on various aspects of the game. These aspects may include, but are not limited to, final game outcomes, individual player performances, or specific in-game events such as successful three-point shots or dunks.

Betting system 67 may utilize data from sensors 30 and cameras 36 to provide accurate and up-to-date information for betting purposes. This integration may allow for dynamic odds adjustments based on real-time game events and player performances.

To ensure fair play, betting system 67 may incorporate safeguards and verification mechanisms. In some implementations, betting system 67 may include algorithms to detect unusual betting patterns or potential collusion between players and bettors. Betting system 67 may also enforce betting limits and implement responsible gambling features to promote ethical participation. Betting system 67 may present a betting interface (not shown) that is accessible through various means. In some cases, spectators may access betting system 67 through mobile applications or dedicated terminals located near court 14. The betting interface may display current odds, available bets, and real-time game statistics to inform betting decisions.

To enhance the overall experience, betting system 67 may incorporate interactive elements. For example, betting system 67 may offer live commentary or analysis related to ongoing bets, or provide visual representations of betting trends projected onto court 14 or surrounding displays 31.

In some implementations, betting system 67 may include a virtual currency or points system for recreational betting without financial stakes. This feature may allow for broader participation and engagement, particularly in settings where monetary betting may not be appropriate or legal.

Betting system 67 may also offer customization options for different types of events or tournaments. For instance, betting system 67 may support bracket-style betting for multi-game tournaments or allow for the creation of custom prop bets tailored to specific events or player matchups.

In some cases, betting system 67 may incorporate social features, allowing spectators to form betting groups, share predictions, or compete in leaderboards based on their betting performance over time. These social elements may foster community engagement and increase the entertainment value for non-playing participants.

Betting system 67 may also provide post-game analytics and summaries related to betting activities. This feature may include visualizations of betting trends, payout statistics, and comparisons between predicted and actual outcomes, offering insights that may inform future betting strategies.

To accommodate various regulatory environments, betting system 67 may be designed with flexibility to adapt to different legal requirements. In some implementations, betting system 67 may offer region-specific configurations to ensure compliance with local gambling laws and regulations.

Betting system 67 may also integrate with highlight system 66, allowing bettors to access relevant video clips or replays that pertain to their wagers. This integration may enhance the betting experience by providing visual context for bet outcomes and game events.

In some cases, betting system 67 may incorporate machine learning algorithms to analyze historical betting data and game outcomes. These algorithms may be used to generate more accurate odds predictions or to identify patterns in betting behavior that could inform system improvements.

Betting system 67 may also offer educational components to inform users about responsible betting practices and the nature of odds and probability. This feature may include tutorials, informational pop-ups, or optional quizzes to promote informed and responsible participation.

In some implementations, betting system 67 may support multiple languages and currencies to accommodate diverse user bases and international events. System 12 may automatically adjust displays and betting options based on user preferences or location data.

Betting system 67 may also include features for event organizers or venue operators to customize betting options and set parameters such as maximum bet amounts, types of bets allowed, or specific rules for different types of events or age groups.

In some cases, betting system 67 may offer a simulation mode where users can practice betting strategies using historical data or simulated games without financial risk. This feature may serve as a training tool for new users or as an additional entertainment option.

Betting system 67 may also incorporate augmented reality (AR) features, allowing spectators to view real-time odds or betting information overlaid on their view of the court when using compatible devices. This AR integration may provide an immersive and interactive betting experience for on-site spectators.

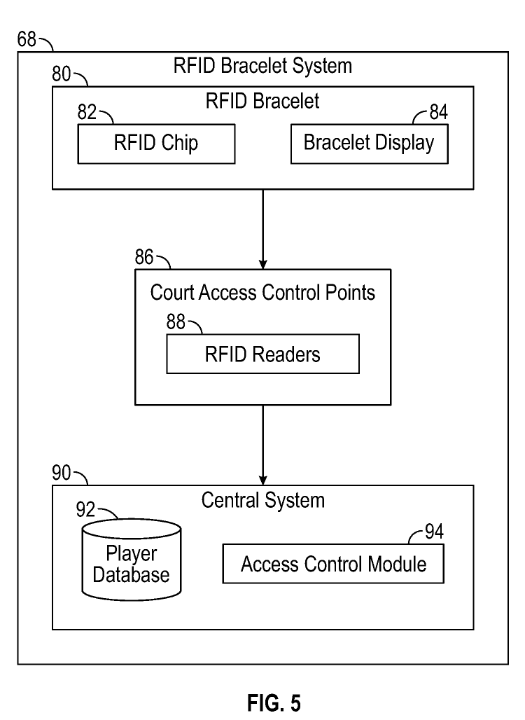

System 12 communicatively connects to a Radio Frequency Identification (RFID) bracelet system 68. RFID bracelet system 68 indicates a system configured to manage bracelets worn by players 70 during the play. RFID bracelet system 68 is used for access control and player tracking. RFID bracelet system 68 may enhance security, enable personalized experiences, and streamline player management within the court environment. FIG. 5 shows a block diagram of RFID bracelet system 68, in accordance with one embodiment of the present invention. RFID bracelet system 68 includes a RFID bracelet 80. In the present invention, each player 70 may be issued a unique RFID bracelet 80 upon registration. These RFID bracelets 80 may contain a small RFID chip 82 that stores a unique identifier associated with the player's account. Further, each RFID bracelet 80 may include a bracelet display 84 configured to display the player ID, points scored, time left, etc. RFID bracelet system 68 includes court access control points 86 positioned entry points and strategic locations throughout court 14. Court access control points 86 may be equipped with RFID readers 88 for detecting and reading RFID bracelet 80. Further, RFID bracelet system 68 includes a central system 90 having a player database 92 and an access control module 94. In use, RFID bracelet system 68 may interface with system 12 through a secure communication protocol. When player 70 approaches court 14, RFID readers 88 may detect RFID bracelet 80 and transmit the player's identifier to central system 90. Central system 90 may then verify the player's authorization and grant or deny access accordingly.

In some implementations, RFID bracelet system 68 may enable personalized experiences for players. Upon detection of a player's RFID bracelet 80, RFID bracelet system 68 may load individual preferences, such as preferred game modes or difficulty settings. RFID bracelet system 68 may also track and store performance data associated with each player's unique identifier, allowing for long-term progress monitoring and personalized training recommendations.

In some cases, RFID bracelets 80 may serve as a secure method for accessing various features of system 12. For example, players 70 may use their RFID bracelets 80 to start games, access lockers, or make purchases within the facility. In some implementations, RFID bracelet system 68 may integrate with a broader facility management system (not shown), allowing for coordinated access control across various areas such as locker rooms, vending machines, or associated entertainment zones. In some cases, RFID bracelet system 68 may support different levels of access based on bracelet type. For instance, standard player RFID bracelets 80 may grant basic court access, while premium bracelets may unlock additional features or provide priority booking. To enhance security and prevent unauthorized access, RFID bracelet system 68 may employ encryption techniques and regularly update access codes. RFID bracelet system 68 may also include safeguards against cloning or tampering with RFID bracelets 80.

RFID bracelet system 68 may also facilitate multi-player management, allowing system 12 to automatically recognize team compositions and adjust game settings accordingly. In some cases, RFID bracelet system 68 may use RFID data to enforce time limits or manage court reservations, ensuring fair and efficient use of the facilities.

Variations in wearable technology may be implemented to enhance the player tracking and access control system. In some implementations, the system may utilize smart wristbands with built-in displays, allowing players to view real-time stats or receive notifications. Alternatively, system 12 may support smartphone-based virtual RFID tags, enabling players to use their mobile devices for access and tracking purposes.

Additional features that may be incorporated into the wearable technology include biometric sensors for health monitoring, accelerometers for more detailed movement tracking, or near-field communication (NFC) capabilities for seamless interactions with court equipment.

In some implementations, system 12 may support network connectivity, allowing for multiplayer experiences across different court locations or online integration. This feature may enable tournaments, remote coaching, or social gaming experiences that extend beyond the physical court space.

The interactive basketball court system 12 described herein may be adapted to various alternative embodiments and future enhancements. In some cases, court 14 dimensions may be modified to accommodate different playing spaces or game formats. For example, court 14 size may be adjusted to fit within smaller venues or expanded for larger facilities.

Sensors 30 utilized in system 12 may be varied or upgraded. In some implementations, different types of sensors 30 may be employed for player tracking and ball detection. For instance, a pressure-sensitive flooring (not shown) may be incorporated to provide additional data on player movements and positioning.

The game modes offered by system 12 may be expanded or customized. In some cases, new game variants may be developed that incorporate elements from other sports or introduce novel gameplay mechanics. System 12 may allow for the creation and integration of user-generated game modes, enhancing the system's versatility.

System 12 does not require the use of virtual reality (VR) headsets for gameplay, ensuring an immersive experience without VR equipment.

Artificial intelligence (AI) capabilities may be incorporated into system 12 for advanced player analysis. In some cases, AI algorithms may process gameplay data to provide detailed insights into player performance, suggest personalized training regimens, or predict game outcomes based on historical data.

The core technology of system 12 may be adapted for use in other sports. In some implementations, the sensor and projection systems may be reconfigured to support sports such as volleyball, tennis, or soccer, with sport-specific gameplay elements and feedback mechanisms.

Enhanced connectivity features may be developed for system 12. In some cases, remote play capabilities may allow players in different physical locations to compete against each other in real-time, with actions on one court reflected through projections on another.

Betting system 67 associated with court 14 may be expanded to include more complex wagering options or integration with cryptocurrency platforms. In some implementations, a blockchain-based system (not shown) may be used to ensure transparency and security in betting transactions.

Advancements in projection technology may be incorporated to improve the visual quality and interactivity of the court surface. In some cases, high-resolution, low-latency projectors may enable more detailed and responsive visual feedback during gameplay.

Highlight system 66 may be enhanced with automated editing capabilities powered by machine learning algorithms. In some implementations, these algorithms may analyze gameplay footage to identify and compile the most exciting or significant moments without human intervention.

Biometric sensors (not shown) may be integrated into the player wearables to provide additional health and performance data. In some cases, this data may be used to monitor player fatigue, optimize training schedules, or provide real-time health alerts during gameplay.

The system's software may be developed to include more sophisticated analytics tools for coaches and trainers. In some implementations, these tools may offer detailed breakdowns of team strategies, player interactions, and performance trends over time.

Haptic feedback mechanisms (not shown) may be incorporated into the court surface or player equipment. In some cases, this tactile feedback may provide additional sensory information to players, enhancing their awareness of game events or improving skill development.

Environmental controls (not shown) may be integrated into the court system to create varying playing conditions. In some implementations, temperature, humidity, or air flow may be adjusted to simulate different climates or challenge players in unique ways.

Audiovisual feedback controller 56 may be enhanced with spatial audio technologies. In some cases, this may allow for more immersive and directional sound effects that correspond precisely to on-court actions and positions.

These alternative embodiments and potential future enhancements demonstrate the adaptability and extensibility of the interactive basketball court system. As technology continues to advance, additional features and capabilities may be developed to further enhance the user experience and expand the system's applications.

System 12 may incorporate features that enable gameplay interactions between multiple courts, whether they are located in the same venue or across different locations. This interconnected gameplay capability may enhance the competitive experience and create new opportunities for engagement among players and spectators.

In some implementations, system 12 may allow for real-time score synchronization between courts. When players 70 on one court score points, the updated score may be instantly displayed on the other connected courts. This feature may enable simultaneous competitions or create a sense of shared gameplay experience across multiple locations.

System 12 may also be capable of projecting shot locations from one court onto another. For example, when a player takes a shot on Court 1, the exact location of that shot may be visually represented on Court 2 through the projection system. This feature may allow players to see and react to actions occurring on other courts, potentially influencing their own gameplay strategies.

In cases where courts are adjacent within the same venue, system 12 may utilize direct network connections to ensure minimal latency in data transmission between courts. This may enable near-instantaneous updates of scores, shot locations, and other relevant gameplay information across all connected courts.

For courts located in separate venues, system 12 may employ secure internet protocols to facilitate real-time data exchange. In some implementations, dedicated high-speed connections may be used to minimize lag and ensure a smooth, synchronized experience across geographically distant locations.

System 12 may support various modes of inter-court gameplay. In some cases, players on different courts may compete directly against each other in virtual matches, with each team's actions on their physical court affecting the shared virtual gameplay space. This may create unique hybrid experiences that blend local physical play with remote virtual competition.

In other implementations, system 12 may enable cooperative gameplay modes across multiple courts. For instance, players on different courts may work together to achieve shared objectives, with their combined scores and actions contributing to a common goal. This feature may foster teamwork and collaboration among players in different locations.

System 12 may also incorporate spectator engagement features. In some cases, actions occurring on one court may trigger interactive elements or challenges for spectators on other courts, creating a more immersive and participatory viewing experience.

To enhance the sense of connection between courts, system 12 may include audio-visual communication features. In some implementations, live video feeds from other courts may be projected onto designated areas of each court, allowing players and spectators to see and hear their remote counterparts in real-time.

System 12 may offer customizable options for inter-court interactions. In some cases, court operators or event organizers may be able to define the level and type of interaction between specific courts, allowing for tailored experiences based on the nature of the event or the preferences of the participants.

For tournaments or league play spanning multiple venues, system 12 may provide comprehensive leaderboards and statistics that aggregate data from all connected courts. This feature may allow players and spectators to track overall standings and performance metrics across the entire network of participating courts.

In some implementations, system 12 may support asymmetric gameplay between courts of different sizes or configurations. The software may automatically adjust game parameters and scoring to ensure fair competition, even when the physical dimensions or equipment of the connected courts differ.

The inter-court gameplay features may extend to the betting system as well. In some cases, spectators on one court may be able to place bets on games occurring on other connected courts, expanding the potential for engagement and interaction across venues.

To manage the increased data flow and processing requirements of inter-court gameplay, system 12 may employ edge computing techniques. In some implementations, local CCA systems 40 at each court 14 may handle immediate gameplay calculations, while a centralized server (not shown) manages the synchronization and distribution of data across the network of courts.

System 12 may also incorporate adaptive networking protocols to maintain smooth inter-court gameplay experiences even in challenging network conditions. These protocols may dynamically adjust data transmission rates and prioritize critical gameplay information to minimize disruptions due to network latency or bandwidth limitations.

In some cases, system 12 may offer a replay sharing feature across connected courts. Particularly impressive plays or significant moments from one court may be instantly shared and displayed on other courts, fostering a sense of shared experience and friendly competition among players in different locations.

The inter-court gameplay capabilities may also extend to training and coaching applications. In some implementations, coaches may be able to demonstrate techniques or run drills on one court, with the actions and instructions being simultaneously projected onto multiple other courts for synchronized team training sessions across different locations.

System 12 may incorporate spectator-initiated physical interference features, enhancing engagement and adding dynamic elements to gameplay. In some implementations, these features may allow spectators to directly influence the game through controlled physical mechanisms, creating a unique blend of player skill and audience participation.

In some cases, basketball board 26 may also be designed to rotate 90 degrees to either side. This rotational capability may introduce new dimensions to gameplay and training exercises. For example, the rotation may be used to create challenging shot angles or simulate different court positions without requiring players to physically move to a new location.

In some implementations, the movement and rotation of basketball board 26 may be controlled through the same central protocol that operates the interactive court system. This integration may allow for seamless incorporation of the board's dynamic features into various game modes and training programs.

The height-adjustable and rotating basketball board 26 may offer several potential applications in gameplay and training scenarios. For instance, system 12 may automatically adjust the board's height based on the player's physical characteristics or skill level, providing a more personalized and challenging experience. The rotation feature may be utilized in drills designed to improve a player's ability to shoot from different angles or adapt to changing defensive scenarios.

In some cases, the design of the height-adjustable and rotating basketball board 26 may vary. For example, the mechanism for height adjustment may use hydraulic systems, electric motors, or other mechanical means. The rotation mechanism may employ a motorized turntable or a manual locking system that allows for preset rotation angles.

The functionality of basketball board 26 may be further enhanced by incorporating additional sensors or visual markers. These enhancements may allow for more precise tracking of the board's position and orientation, enabling more complex interactions with the game system and providing more detailed feedback to players.

In some implementations, the height and rotation of basketball board 26 may be programmed to change dynamically during gameplay, adding an element of unpredictability and requiring players to adapt quickly to changing conditions. This feature may be particularly useful for advanced training scenarios or competitive gameplay modes.

The height-adjustable and rotating basketball board 26 may also be designed with safety features to prevent unintended movement during play. These safety measures may include locking mechanisms, slow movement speeds, and sensors to detect player proximity before initiating any changes in height or rotation.

System 12 may include robotic arms (not shown) positioned near basketball board 26. Here, the robotic arms act as spectator-initiated physical interference mechanisms that are integrated into the gameplay. In some cases, spectators may activate the robotic arms through a mobile application or dedicated control stations. When triggered, the robotic arm may swipe across the basketball board 26 or rim 28, potentially altering the trajectory of shots or rebounds. The timing and frequency of these interventions may be regulated by the game software to maintain fair play and prevent excessive disruption.

Retractable obstacles (not shown) may be integrated into the court floor. In some implementations, the spectators may vote to activate these obstacles, which may rise from the floor at strategic locations. These obstacles may take various forms, such as small barriers or uneven surfaces, challenging players to adapt their movements and ball handling in real-time.

System 12 may feature ceiling-mounted props that can be deployed during gameplay. In some cases, spectators may trigger the release of these props, which may descend onto the court at predetermined locations. These props may include hanging targets, movable hoops, or inflatable barriers that players must navigate around or incorporate into their strategies.

Dynamic lighting effects controlled by spectators may be incorporated into the gameplay. In some implementations, the spectators may activate specific lighting patterns or colors that temporarily alter the visual environment of the court. These lighting changes may affect player perception, ball visibility, or highlight certain areas of the court, adding an extra layer of challenge and unpredictability to the game.

Game operating system 54 may incorporate a game design interface that allows users to create custom game formats. This feature may enable players, coaches, or event organizers to tailor the gameplay experience to their specific needs or preferences, enhancing the system's versatility and appeal to a wide range of users. In some implementations, the game design interface may offer a user-friendly platform accessible through mobile devices, tablets, or dedicated terminals near the court. Users may be able to adjust various parameters to create unique game modes. For example, the interface may allow users to set custom game durations, ranging from quick practice sessions to extended tournament-style matches.

Game operating system 54 may provide options for users to modify scoring rules within their custom game formats. In some cases, the users may be able to assign different point values to shots made from specific areas of the court, create bonus scoring zones that appear dynamically during gameplay, or implement multipliers for consecutive successful shots. This flexibility in scoring rules may encourage players to develop diverse skills and strategies.

In some implementations, system 12 may include a diagnostics and maintenance module (not shown). The diagnostics and maintenance module may monitor the health and performance of various hardware components, schedule software updates, and provide alerts for potential issues. In some implementations, the diagnostics and maintenance module may support remote diagnostics and troubleshooting capabilities.

A non-transitory computer-readable medium storing the software may be organized into multiple partitions or sections to optimize data access and system performance. In some cases, frequently accessed game data and core system files may be stored in high-speed memory regions, while historical data and less frequently used modules may be stored in separate areas.

The computer-readable medium may also store configuration files and system parameters that define the behavior of various software components. These files may be easily modifiable, allowing system administrators to fine-tune the court's performance without requiring extensive software changes.

In some implementations, the non-transitory computer-readable medium may include a secure storage area for sensitive information, such as user profiles, payment data, or proprietary game algorithms. This secure storage may employ encryption and access control mechanisms to protect against unauthorized access or data breaches.

The computer-readable medium may also store a comprehensive logging system that records system events, user actions, and error messages. This log data may be invaluable for system troubleshooting, performance optimization, and auditing purposes.

A number of implementations have been described. Nevertheless, it will be understood that various modifications may be made without departing from the spirit and scope of the disclosure. Accordingly, other implementations are within the scope of the following claims.

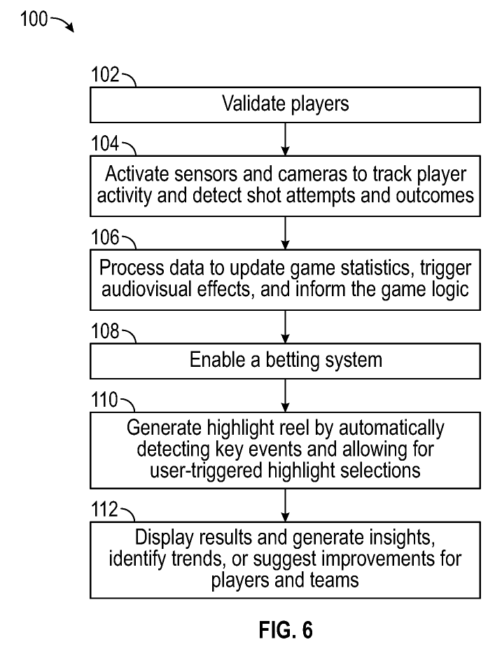

Now referring to FIG. 6, a method 100 for operating an interactive immersive basketball court system is explained, in accordance with one exemplary embodiment of the present invention. The method 100 may be described in the general context of computer executable instructions. Generally, computer executable instructions may include routines, programs, objects, components, data structures, procedures, modules, functions, etc., that perform particular functions or implement particular abstract data types. The method 100 may also be practiced in a distributed computing environment where functions are performed by remote processing devices that are linked through a communications network. In a distributed computing environment, computer executable instructions may be located in both local and remote computer storage media, including memory storage devices.

The order in which the method 100 is described and is not intended to be construed as a limitation, and any number of the described method blocks can be combined in any order to implement the method 100 or alternate methods. Additionally, blocks may be deleted from the method 100 without departing from the scope of the invention described herein. Furthermore, the method may be implemented in any suitable hardware, software, firmware, or combination thereof. However, for ease of explanation, in the embodiments described below, the method 100 may be implemented in the above-described system 12.

Method 100 may begin with validating user/player access to court 14. In some implementations, the validation process may involve the use of RFID bracelets 80 or other wearable devices that contain unique identifiers associated with registered players (step 102).

Upon successful validation, system 12 may activate a network of sensors 30 and cameras 36 positioned around court 14 (step 104). Sensors 30 and cameras 36 may work in concert to track player activity, including movements, positions, and interactions with the ball and court equipment. As specified above, sensors 30 may include optical sensors 32 and accelerometers 34 near basketball board 26 to detect shot attempts and outcomes.

As gameplay commences, system 12 may continuously process (step 106) the collected data in real-time. This processing may involve analyzing player positions, ball trajectory, and game events using sophisticated algorithms and potentially machine learning techniques. The processed data may be used to update game statistics, trigger audiovisual effects, and inform the game logic.

During gameplay, system 12 may adjust various court elements based on the game mode or specific events. For example, the height of at least one basketball board 26 may be dynamically adjusted between 8 feet and 12 feet. In some cases, basketball board 26 may also be rotated by up to 90 degrees to either side, introducing new challenges or gameplay variations.

The method may include enabling betting system 67 (step 108) for non-playing participants. Betting system 67 may allow spectators to place bets on various aspects of the game, such as final outcomes, player performances, or specific in-game events. Betting system 67 may update odds in real-time based on the gameplay data being processed.

Throughout the game, system 12 may employ highlight system 66 to generate a highlight reel by automatically detecting key events and allowing for user-triggered highlight selections (step 110). Highlight system 66 may employ machine learning algorithms to identify significant moments and compile them into a cohesive video package.

As the game progresses, system 12 may continuously update game statistics, player performance metrics, and other relevant data. This information may be displayed in real-time through the projection system or made available through user interfaces accessible to players, coaches, or spectators (step 112).

When the game concludes, system 12 may transition to a game end state. At this point, users may be able to review their results, including detailed performance statistics, highlight reels, and any relevant betting outcomes. In some implementations, this data may be stored for future reference or used to inform player development strategies.

Method 100 may also include post-game analysis features, where system 12 processes the collected data to generate insights, identify trends, or suggest improvements for players and teams. This analysis may incorporate AI capabilities to provide personalized feedback and training recommendations.

Throughout the entire process, system 12 may maintain secure communication protocols and implement measures to protect sensitive data, such as player information or betting transactions. Regular system diagnostics and maintenance routines may be performed to ensure optimal performance and reliability of all components.

This method of operating an interactive basketball court integrates various technological elements to create a dynamic, engaging, and data-rich basketball experience that extends beyond traditional gameplay.

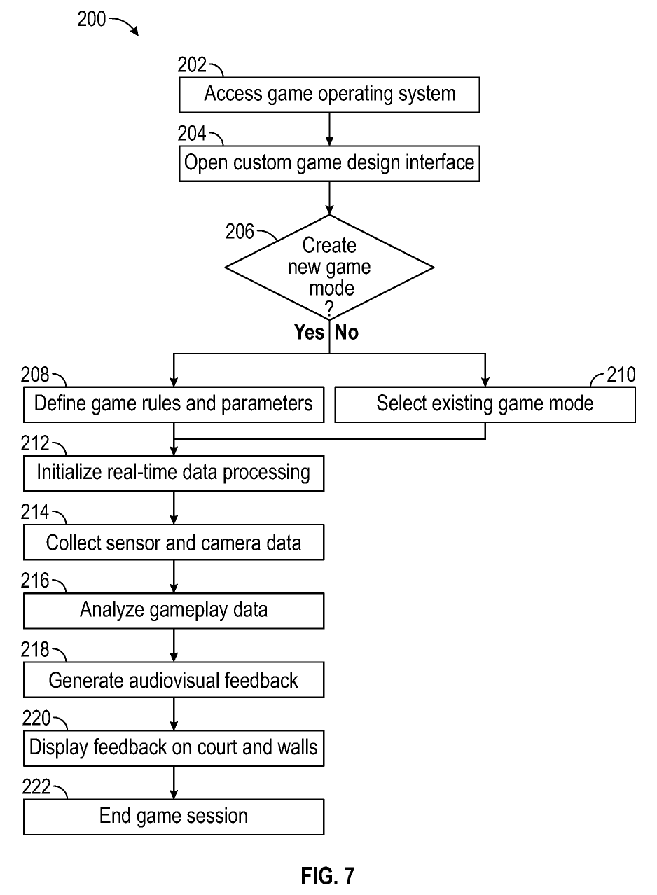

FIG. 7 shows a method 200 of operating a game operating system by administrators or users for creating and modifying game modes, in accordance with one exemplary embodiment of the present invention. Method 200 starts at step 202, where the administrators access the game operating system i.e., CCA system 40. Here, the administrators open custom game design interface (step 204) to customize or modify game modes according to their preferences. At step 206, system 12 checks if a new game mode needs to be created. If new game mode is required, then new game rules and parameters are defined, as shown in step 208. If new game mode is not required at step 206, then system 12 allows the users to select existing game mode, as shown at step 210. Upon selecting the game mode, method 200 moves to step 212. At step 212, system 12 starts to capture real-time game statistics and adjusts the gameplay by capturing data from sensors 30 and camera 36 (step 214). At step 216, system 12 analyses the gameplay and generates audiovisual feedback (step 218). The visual feedback is displayed on court 14 and/or walls 18 to enhance the visual experience for the users (step 220). Further, system 12 displays the results on display 31 during the play and after conclusion of the game. At step 222, system 12 ends the game session and stores the results.

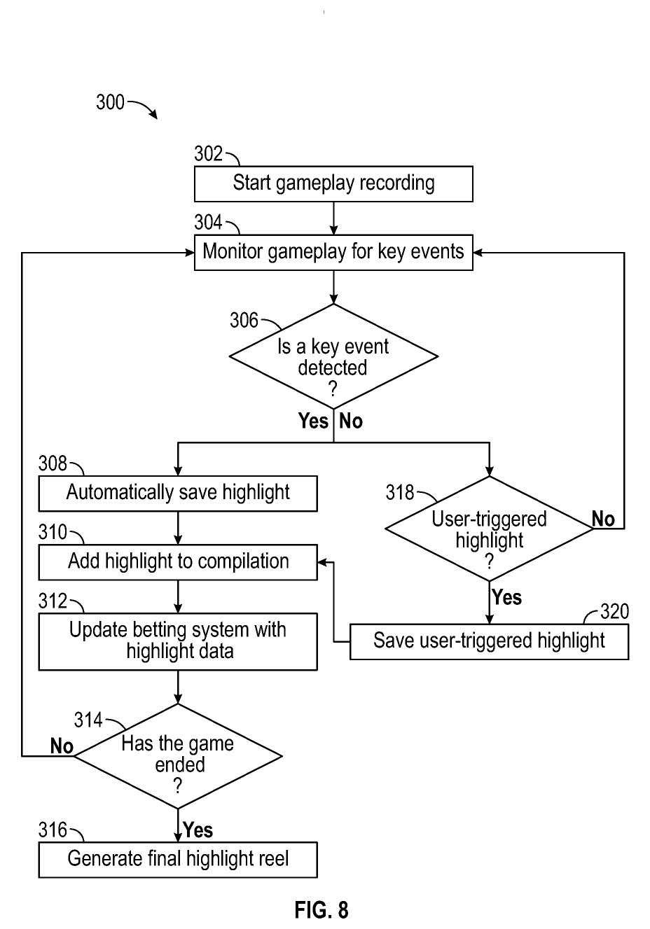

FIG. 8 shows a method 300 of detecting key events by highlight system 66 for generating highlight reels. Method 300 starts at step 302. At step 302, highlight system 66 initiates the recording of gameplay. Further, highlight system 66 monitors the gameplay for detecting key events (step 304) by correlating visual cues from the video feed from cameras 36 and data from sensors 30 to accurately identify successful baskets or missed attempts. At step 306, highlight system 66 checks whether a key event has been detected. If a key event is detected, highlight system 66 automatically saves the highlight (step 308) and adds highlight to compilation (step 310). The compilations can be used for replay, analysis, or broadcasting to other users/spectators. At step 312, highlight system 66 integrates with the highlight data with betting system 67 to offer a more interactive and informed betting experience compared to traditional sports wagering. At step 314, highlight system 66 checks whether the game has ended. If the game has ended, then highlight system 66 generates a final highlight reel (step 316). If the game is not ended at step 314, then method 300 moves back to step 304 to monitor and detect key events.

If the key event is not detected at step 306, then method 300 moves to step 318. Here, highlight system 66 checks (step 318) if there is a user-triggered highlight i.e., user selects a certain portion of video from the play to be included in the highlight reel. If the user-triggered highlight is detected, then method 200 moves to step 320 to save the highlight and then adds to compilation of highlight (step 310). If the user-triggered highlight is not detected at step 318, method 300 moves back to step 304 to monitor for key events during the gameplay.

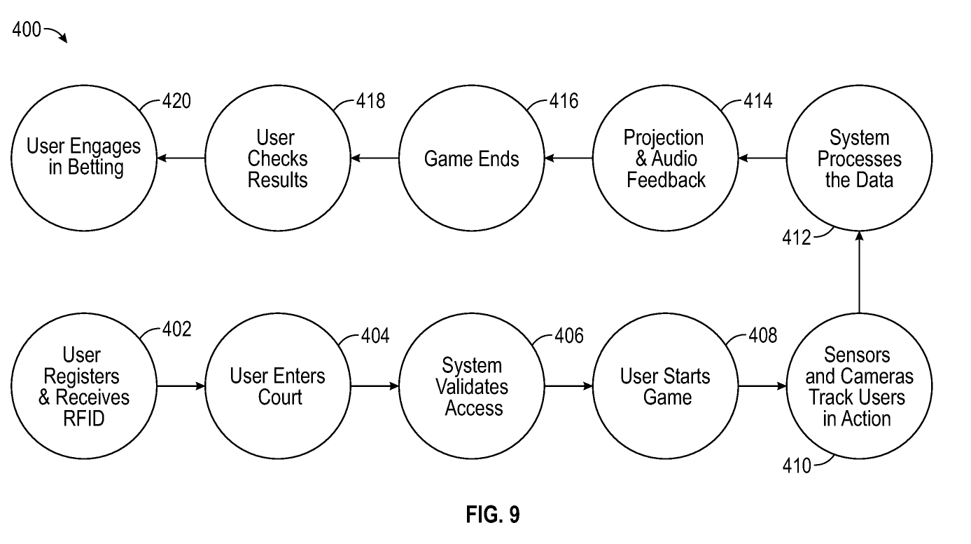

FIG. 9 shows a general process flow 400 depicting the sequence of events from user registration to game completion. The process 400 may begin with user registration (step 402). During registration, a user may receive an RFID device. This RFID device may serve as a unique identifier for the user within the system.

Following registration, the user may enter the court area (step 404). Upon entry, system 12 may validate the user's access through RFID verification (step 406). This step may ensure that only authorized users can participate in games on the court.

After successful access validation, the user may start the game (step 408). The initiation of the game may trigger the activation of sensors 30 and cameras 36 positioned around the court. Sensors 30 and cameras 36 may track the activity of the users throughout the gameplay (step 410).

As the game progresses, system 12 may process the data collected from sensors 30 and cameras 36 (step 412). This data processing may occur in real-time, allowing for immediate analysis of player movements and actions.

Based on the processed data, system 12 may provide feedback to the user. This feedback may take the form of projections onto the court or sides of the court, as well as audio feedback (step 414). The audiovisual feedback may be dynamically adjusted based on the ongoing gameplay.

When the game concludes (step 416), the system may transition to a game end state. At this point, users may have the opportunity to check their results (step 418) from the completed game. System 12 may compile and present various performance metrics and statistics to the users.

In some cases, system 12 may incorporate a betting feature utilizing betting system 67. Users may engage in betting activities before or during gameplay (step 420). Betting system 67 may be integrated with the results checking step, allowing users to track the outcomes of their bets.

The user interaction flow may include variations or additional features. For example, system 12 may offer different game modes that users can select before starting a game. The RFID validation process may be expanded to include personalized settings or preferences for each user. The feedback mechanisms may be customized based on user preferences or skill levels.

Betting system 67 may be further developed to include real-time odds adjustments based on gameplay or to offer various types of bets beyond simple win/lose scenarios. Additionally, system 12 may incorporate social features, allowing users to share their results or challenge other players to matches.

By integrating these various components and features, the interactive immersive basketball court system 12 may provide a comprehensive and engaging user experience, from initial registration through gameplay to post-game analysis and optional betting activities.

In some implementations, system 12 may include a pause or resume feature, allowing users to temporarily halt and later continue their game session. The results checking step may be expanded to include detailed performance analysis or comparisons with previous games or other players.

### Advantages

The interactive immersive basketball court system described herein may offer several advantages and improvements over prior art systems and methods. These advantages may stem from the integration of advanced technologies, innovative design features, and comprehensive software solutions.

In some aspects, the system may provide a more engaging and immersive gameplay experience compared to traditional basketball courts. The incorporation of real-time audiovisual feedback projected onto the court surface and surrounding walls may create a dynamic playing environment that responds to player actions. This interactive element may enhance player engagement and motivation, potentially leading to improved skill development and increased enjoyment of the game.

The adjustable and rotatable basketball board may offer unique training opportunities and gameplay variations not typically available in standard court setups. The ability to modify the height and angle of the board may allow for a wider range of practice scenarios and game modes, catering to players of different skill levels and physical attributes. This feature may also enable the creation of novel training exercises and competitive challenges that were not previously possible.

In some implementations, the sophisticated sensor and camera network may provide more accurate and comprehensive tracking of player movements and ball trajectories compared to earlier systems. This enhanced tracking capability may result in more precise performance analytics and gameplay statistics, offering valuable insights for players, coaches, and spectators. The real-time nature of this data collection and analysis may allow for immediate feedback and adjustments during gameplay or training sessions.

The integration of RFID technology for player access control may offer improved security and personalization compared to traditional court management systems. This feature may allow for better tracking of court usage, simplified access management, and the potential for personalized gameplay experiences based on individual player profiles.

The software suite powering the interactive court system may provide several advantages in terms of flexibility and customization. The ability to create and modify game modes through a user-friendly interface may allow for continuous innovation in gameplay experiences. This adaptability may help maintain player interest over time and cater to diverse preferences and skill levels.

The comprehensive data management and analytics capabilities of the system may offer significant advantages for player development and performance analysis. The ability to collect, store, and analyze large volumes of gameplay data may provide coaches and players with deeper insights into performance trends, strengths, and areas for improvement.

In some implementations, the cloud integration and remote management features may offer improved operational efficiency compared to standalone court systems. These features may allow for easier software updates, system monitoring, and troubleshooting, potentially reducing downtime and maintenance costs.

The modular design of the software suite may provide advantages in terms of system scalability and future-proofing. The ability to add or upgrade individual modules may allow court operators to adapt to new technologies or changing user preferences without requiring a complete system overhaul.

Overall, the interactive immersive basketball court system may represent a significant advancement in sports technology, offering a blend of enhanced gameplay experiences, sophisticated analytics, and flexible management tools that may set it apart from prior art solutions in the field of interactive sports environments.

### Definitions

As used herein, the term "court" may refer to a playing surface designed for basketball activities, which may include standard court markings, boundaries, and associated equipment such as basketball hoops and backboards.

As used herein, the term "sensor" may refer to a device capable of detecting and responding to physical input from its environment, such as movement, pressure, light, or sound, and converting it into an electrical signal for processing.

As used herein, the term "camera" may refer to an optical instrument used for capturing and recording visual images, which may include still photographs or video footage.

As used herein, the term "audiovisual feedback" may refer to a combination of visual and auditory information provided to users in response to their actions or game events, which may be generated and displayed in real-time.

As used herein, the term "game mode" may refer to a specific set of rules, objectives, and parameters that define how a basketball game or training session is played or conducted within the interactive court system.

As used herein, the term "RFID" (Radio-Frequency Identification) may refer to a technology that uses electromagnetic fields to automatically identify and track tags attached to objects or worn by individuals.

As used herein, the term "highlight reel" may refer to a compilation of notable or impressive moments from a game or training session, which may be automatically generated or user-selected.

As used herein, the term "projection system" may refer to equipment used to display visual content onto surfaces such as walls or floors, which may include one or more projectors and associated software for image processing and mapping.

As used herein, the term "machine learning" may refer to a subset of artificial intelligence that involves computer algorithms improving automatically through experience and data analysis, without being explicitly programmed.

As used herein, the term "user interface" may refer to the means by which users interact with the interactive basketball court system, which may include graphical displays, touch screens, voice commands, or physical controls.

### REFERENCE NUMERALS

10 - environment
12 - basketball system
14 - basketball court
16 - floor
18 - walls
20 - court lines
22 - poles
24 - extended arm
26 - basketball board
28 - rim
29 - net
30 - sensor array
31 - display
32 - accelerometer
34 - optical sensor
36 - camera array
40 - centralized communication system
42 - data collection module
44 - sensor input handler
46 - camera feed processor
48 - data processing unit
50 - player tracking module
52 - shot detection system
54 - game operating system
56 - audiovisual feedback controller
58 - projection interface
60 - audio interface
62 - projection system
64 - audio system
66 - highlight system
67 - betting system
68 - bracelet system
72 - basketball
74 - projection areas
80 - identification bracelet
82 - identification chip
84 - status display
86 - access control points
88 - identification readers
90 - control system
92 - user database
94 - access module

### CLAUSES

Clause 1. A basketball court system comprising: at least one basketball board; a plurality of sensors for detecting shot accuracy and player movements; a plurality of cameras for tracking player positions and game interactions; a centralized communication and analysis system that collects and processes gameplay data; a projection system for displaying real-time audiovisual feedback onto at least one surface of the court; and a game operating system enabling custom game design and updates.

Clause 2. The basketball court system of clause 1, wherein the at least one basketball board is an adjustable basketball board wherein it is height-adjustable between 8 feet and 12 feet, and wherein the at least one basketball board is rotatable by 90 degrees to either side.

Clause 3. The basketball court system of clause 1, wherein the plurality of sensors comprises optical sensors and accelerometers for detecting ball interactions with the board and rim.

Clause 4. The basketball court system of clause 1, further comprising RFID bracelets for controlled player access to the court.

Clause 5. The basketball court system of clause 4, further comprising a betting system allowing non-playing participants to place bets on active players.

Clause 6. The basketball court system of clause 5, further comprising: a highlight system that records gameplay, automatically detects key events, and allows user-triggered highlight saving, wherein the highlight system integrates with the betting system to provide relevant video clips for wagers, incorporates machine learning algorithms to improve event detection over time, offers customizable highlight preferences for users, and includes augmented reality features for viewing betting information overlaid on the court when using compatible devices, and includes spectator-initiated physical interference mechanisms integrated into the gameplay; and wherein the physical interference mechanisms comprise at least one of: a robotic arm positioned near the at least one basketball board, wherein the robotic arm is configured to swipe across the board or rim during gameplay; retractable obstacles integrated into the court floor, wherein the retractable obstacles are configured to rise from the floor at predetermined locations; ceiling-mounted props configured to descend onto the court at specified positions during gameplay; dynamic lighting elements configured to alter the visual environment of the court; wherein the spectator-initiated physical interference mechanisms are controlled through the game operating system and synchronized with the real-time audiovisual feedback to create an interactive gameplay experience influenced by spectator actions; and wherein the game operating system further comprises a game design interface that allows users to create custom game formats, comprising at least one of game duration, scoring rules, and custom court layouts.

Clause 7. The basketball court system of clause 1, further comprising: at least two basketball courts, each court comprising the at least one basketball board, the plurality of sensors, the plurality of cameras, and the projection system; wherein the centralized communication and analysis system collects and processes gameplay data from each of the at least two basketball courts; and wherein the game operating system enables synchronized gameplay between the at least two basketball courts by: receiving real-time data from each of the at least two basketball courts; processing the received data to update a shared virtual gameplay space; generating audiovisual feedback for each of the at least two basketball courts based on actions occurring on any of the at least two basketball courts; and transmitting the generated audiovisual feedback to the respective projection systems of each of the at least two basketball courts.

Clause 8. A method of operating an interactive basketball court, comprising: validating user access to the court; activating sensors and cameras to track player activity on the court; processing collected gameplay data; and providing real-time audiovisual feedback based on the processed data.

Clause 9. The method of clause 8, wherein the real-time audiovisual feedback comprises projecting dynamic visuals onto at least one wall and a floor of the basketball court.

Clause 10. The method of clause 9, wherein the dynamic visuals include interactive targets, scoring zones, and player statistics.

Clause 11. The method of clause 10, further comprising adjusting a height of at least one basketball board during gameplay, and further comprising rotating the at least one basketball board by 90 degrees to either side during gameplay.

Clause 12. The method of clause 11, further comprising enabling a betting system for non-playing participants to place bets on active players.

Clause 13. The method of clause 12, wherein the highlight reel is generated based on automatically detected key events and user-triggered highlight selections, and further comprising: generating a highlight reel of gameplay events; integrating biometric sensors into player wearables to provide health and performance data; incorporating haptic feedback mechanisms into the court surface or player equipment; adjusting environmental controls to simulate different playing conditions enhancing the audio feedback system with spatial audio technologies; and utilizing artificial intelligence for advanced player analysis and personalized training recommendations.

Clause 14. The method of clause 9, further comprising: receiving real-time data from at least two basketball courts; processing the received data to update a shared virtual gameplay space; generating audiovisual feedback for each of the at least two basketball courts based on actions occurring on any of the at least two basketball courts; and transmitting the generated audiovisual feedback to respective projection systems of each of the at least two basketball courts.

Clause 15. A non-transitory computer-readable medium storing instructions that, when executed by a processor, cause the processor to perform operations for an interactive basketball game, the operations comprising: receiving data from a plurality of sensors and cameras monitoring a basketball court; analyzing the received data to identify game events and player actions; generating real-time audiovisual feedback based on the analyzed data; and controlling at least one adjustable feature of the basketball court based on the analyzed data.

Clause 16. The non-transitory computer-readable medium of clause 15, wherein the at least one adjustable feature comprises a height-adjustable basketball board.

Clause 17. The non-transitory computer-readable medium of clause 15, wherein controlling the at least one adjustable feature comprises adjusting the height of the basketball board between 8 feet and 12 feet, and wherein the at least one adjustable feature further comprises a rotatable basketball board, and wherein controlling the at least one adjustable feature further comprises rotating the basketball board by 90 degrees to either side.

Clause 18. The non-transitory computer-readable medium of clause 15, wherein the operations further comprise generating a highlight reel based on automatically detected key events and user-triggered highlight selections.

Clause 19. The non-transitory computer-readable medium of clause 18, wherein the operations further comprise: enabling a betting system for non-playing participants to place bets on active players based on the analyzed data and generated highlight reel; incorporating virtual reality technology to create an augmented version of the physical court with additional visual elements; adapting the system for remote play capabilities allowing players in different locations to compete in real-time; integrating a blockchain-based system for transparent betting transactions; and implementing automated editing capabilities for the highlight system powered by machine learning algorithms.

Clause 20. The method of clause 15, wherein the operations further comprise: enabling a betting system for non-playing participants to place bets on active players based on the analyzed data and generated audiovisual feedback; incorporating augmented reality features for viewing betting information overlaid on the court when using compatible devices; adapting the system for remote play capabilities allowing players in different locations to compete in real-time; and implementing automated editing capabilities for generating highlight reels powered by machine learning algorithms.

1. A basketball court system comprising:
at least one basketball board;
a plurality of sensors for detecting shot accuracy and player movements;
a plurality of cameras for tracking player positions and game interactions;
a centralized communication and analysis system that collects and processes gameplay data;
a projection system for displaying real-time audiovisual feedback onto at least one surface of the court; and
a game operating system enabling custom game design and updates.

2. The basketball court system of claim 1, wherein the at least one basketball board is an adjustable basketball board wherein it is height-adjustable between 8 feet and 12 feet, and wherein the at least one basketball board is rotatable by 90 degrees to either side.

3. The basketball court system of claim 1, wherein the plurality of sensors comprises optical sensors and accelerometers for detecting ball interactions with the board and rim.

4. The basketball court system of claim 1, further comprising RFID bracelets for controlled player access to the court.

5. The basketball court system of claim 4, further comprising a betting system allowing non-playing participants to place bets on active players.

6. The basketball court system of claim 5, further comprising:
a highlight system that records gameplay, automatically detects key events, and allows user-triggered highlight saving, wherein the highlight system integrates with the betting system to provide relevant video clips for wagers, incorporates machine learning algorithms to improve event detection over time, offers customizable highlight preferences for users, and includes augmented reality features for viewing betting information overlaid on the court when using compatible devices, and includes spectator-initiated physical interference mechanisms integrated into the gameplay; and
wherein the physical interference mechanisms comprise at least one of:
a robotic arm positioned near the at least one basketball board, wherein the robotic arm is configured to swipe across the board or rim during gameplay; retractable obstacles integrated into the court floor, wherein the retractable obstacles are configured to rise from the floor at predetermined locations; ceiling-mounted props configured to descend onto the court at specified positions during gameplay; dynamic lighting elements configured to alter the visual environment of the court;
wherein the spectator-initiated physical interference mechanisms are controlled through the game operating system and synchronized with the real-time audiovisual feedback to create an interactive gameplay experience influenced by spectator actions; and
wherein the game operating system further comprises a game design interface that allows users to create custom game formats, comprising at least one of game duration, scoring rules, and custom court layouts.

7. The basketball court system of claim 1, further comprising:
at least two basketball courts, each court comprising the at least one basketball board, the plurality of sensors, the plurality of cameras, and the projection system;
wherein the centralized communication and analysis system collects and processes gameplay data from each of the at least two basketball courts; and
wherein the game operating system enables synchronized gameplay between the at least two basketball courts by:
receiving real-time data from each of the at least two basketball courts;
processing the received data to update a shared virtual gameplay space;
generating audiovisual feedback for each of the at least two basketball courts based on actions occurring on any of the at least two basketball courts; and
transmitting the generated audiovisual feedback to the respective projection systems of each of the at least two basketball courts.

8. A method of operating an interactive basketball court, comprising:
validating user access to the court;
activating sensors and cameras to track player activity on the court;
processing collected gameplay data; and
providing real-time audiovisual feedback based on the processed data.

9. The method of claim 8, wherein the real-time audiovisual feedback comprises projecting dynamic visuals onto at least one wall and a floor of the basketball court.

10. The method of claim 9, wherein the dynamic visuals include interactive targets, scoring zones, and player statistics.

11. The method of claim 10, further comprising adjusting a height of at least one basketball board during gameplay, and further comprising rotating the at least one basketball board by 90 degrees to either side during gameplay.

12. The method of claim 11, further comprising enabling a betting system for non-playing participants to place bets on active players.

13. The method of claim 12, wherein the highlight reel is generated based on automatically detected key events and user-triggered highlight selections, and further comprising:
generating a highlight reel of gameplay events;
integrating biometric sensors into player wearables to provide health and performance data;
incorporating haptic feedback mechanisms into the court surface or player equipment;
adjusting environmental controls to simulate different playing conditions
enhancing the audio feedback system with spatial audio technologies; and
utilizing artificial intelligence for advanced player analysis and personalized training recommendations.

14. The method of claim 9, further comprising:
receiving real-time data from at least two basketball courts;
processing the received data to update a shared virtual gameplay space;
generating audiovisual feedback for each of the at least two basketball courts based on actions occurring on any of the at least two basketball courts; and
transmitting the generated audiovisual feedback to respective projection systems of each of the at least two basketball courts.

15. A non-transitory computer-readable medium storing instructions that, when executed by a processor, cause the processor to perform operations for an interactive basketball game, the operations comprising:
receiving data from a plurality of sensors and cameras monitoring a basketball court;
analyzing the received data to identify game events and player actions;
generating real-time audiovisual feedback based on the analyzed data; and
controlling at least one adjustable feature of the basketball court based on the analyzed data.

16. The non-transitory computer-readable medium of claim 15, wherein the at least one adjustable feature comprises a height-adjustable basketball board.

17. The non-transitory computer-readable medium of claim 15, wherein
controlling the at least one adjustable feature comprises adjusting the height of the basketball board between 8 feet and 12 feet, and wherein the at least one adjustable feature further comprises a rotatable basketball board, and
wherein controlling the at least one adjustable feature further comprises rotating the basketball board by 90 degrees to either side.

18. The non-transitory computer-readable medium of claim 15, wherein the operations further comprise generating a highlight reel based on automatically detected key events and user-triggered highlight selections.

19. The non-transitory computer-readable medium of claim 18, wherein the operations further comprise:
enabling a betting system for non-playing participants to place bets on active players based on the analyzed data and generated highlight reel;
incorporating virtual reality technology to create an augmented version of the physical court with additional visual elements;
adapting the system for remote play capabilities allowing players in different locations to compete in real-time;
integrating a blockchain-based system for transparent betting transactions; and
implementing automated editing capabilities for the highlight system powered by machine learning algorithms.

20. The method of claim 15, wherein the operations further comprise:
enabling a betting system for non-playing participants to place bets on active players based on the analyzed data and generated audiovisual feedback;
incorporating augmented reality features for viewing betting information overlaid on the court when using compatible devices;
adapting the system for remote play capabilities allowing players in different locations to compete in real-time; and
implementing automated editing capabilities for generating highlight reels powered by machine learning algorithms.
